(19) United States
(12) Patent Application Publication
(10) Pub. No.: US 2024/0319391 A1
(43) Pub. Date: Sep. 26, 2024

(54) MATERIAL MANAGEMENT WITH CONTINUOUS ONLINE HIGH-TEMPERATURE LIQUID SAMPLING AND ANALYSIS

(71) Applicant: Battelle Energy Alliance, LLC, Idaho Falls, ID (US)

(72) Inventors: Ammon N. Williams, Rigby, ID (US); Ruchi Gakhar, Idaho Falls, ID (US); Piyush Sabharwall, Idaho Falls, ID (US)

(21) Appl. No.: 18/612,061

(22) Filed: Mar. 21, 2024

Related U.S. Application Data
(60) Provisional application No. 63/491,459, filed on Mar. 21, 2023.

(51) Int. Cl. G01T 7/02; G01T 1/16

(52) U.S. Cl. CPC G01T 7/02; G01T 1/16

(57) ABSTRACT

A sampling system for a high-temperature liquid includes a sampling loop, a venturi pump nebulizer, and an optical cell. The sampling loop includes a liquid inlet configured for the high-temperature liquid to flow into the sampling loop from a high-temperature liquid vessel and a liquid return configured for returning the high-temperature liquid to the high-temperature liquid vessel. The venturi pump nebulizer includes a nozzle positioned in the sampling loop downstream of the liquid inlet. The nozzle is configured to introduce a gas stream into the sampling loop to produce a vacuum within the sampling loop that draws the high-temperature liquid into the sampling loop and aerosolizes the high-temperature liquid in the gas stream. The optical cell is configured to receive the aerosolized high-temperature liquid for on-line chemical monitoring thereof. The optical cell includes at least one optical window configured for data acquisition to perform the on-line chemical monitoring.

### CROSS-REFERENCE TO RELATED APPLICATION

This application claims the benefit under 35 U.S.C. § 119(e) of U.S. Provisional Patent Application Ser. No. 63/491,459, filed Mar. 21, 2023, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05ID14517 awarded by the United States Department of Energy. The government has certain rights in the invention.

### TECHNICAL FIELD

The disclosure relates generally to material management, and more specifically to continuous online high-temperature liquid sampling and analysis.

### BACKGROUND

The use of nuclear material requires management and safeguards. All special nuclear material must be tracked and managed according to state (country) and international regulations to prevent proliferation of such material. Historically, tracking nuclear material within a reactor was straightforward because the nuclear fuel was contained within a fuel assembly and could be considered an item (i.e., a discrete structure) by the International Atomic Energy Agency (IAEA). However, with the development of Molten Salt Reactors (MSRs) and pyroprocessing where nuclear material is present in a molten material, such as the MSR coolant, conventional item counting is insufficient for tracking the nuclear material. To track the nuclear material, the concentration of the nuclear material within the coolant and the coolant volume must be determined.

Sampling molten salt from a nuclear process (MSRs or nuclear material pyroprocessing) is difficult due to high temperatures of the molten salt, remote operation of the system, and radiation from the nuclear materials. Under these harsh conditions, collecting samples is complex. Current sampling processes require off-line analysis before compositional data is available.

The above-described background relating to nuclear material management is merely intended to provide a contextual overview of some current issues and is not intended to be exhaustive. Other contextual information may become apparent to those of ordinary skill in the art upon review of the following description, which includes example embodiments.

### BRIEF SUMMARY

In one illustrative embodiment, the disclosure provides a sampling system for a high-temperature liquid. The sampling system includes a sampling loop, a venturi pump nebulizer, and an optical cell. The sampling loop includes a liquid inlet configured for the high-temperature liquid to flow into the sampling loop from a high-temperature liquid vessel and a liquid return configured for returning the high-temperature liquid to the high-temperature liquid vessel. The venturi pump nebulizer includes a nozzle positioned in the sampling loop downstream of the liquid inlet. The nozzle is configured to introduce a gas stream into the sampling loop to produce a vacuum within the sampling loop that draws the high-temperature liquid into the sampling loop and aerosolizes the high-temperature liquid in the gas stream. The optical cell is configured to receive the aerosolized high-temperature liquid for chemical monitoring thereof. The optical cell includes at least one optical window configured for data acquisition to perform the on-line chemical monitoring.

In another illustrative embodiment, the disclosure provides a method for measuring a concentration of material within a high-temperature liquid. The method includes injecting a gas stream, utilizing a venturi pump nebulizer, into a high-temperature liquid in a sampling loop to aerosolize the high-temperature liquid within the gas stream. The method also includes passing the aerosolized high-temperature liquid through an optical cell to acquire data in-situ for chemically monitoring the high-temperature liquid. The method further includes analyzing the data utilizing a chemical monitoring technique.

### BRIEF DESCRIPTION OF THE DRAWINGS

The disclosure is illustrated and described herein with reference to the various drawings, in which like reference numbers are used to denote like system components/method acts, as appropriate, and in which:

FIG. 1 is a schematic illustration of a sampling system of a volume of a high-temperature liquid in accordance with embodiments of the disclosure;

FIG. 2 is a schematic illustration of embodiments of a portion of a sampling loop of the sampling system of FIG. 1;

FIG. 3 is a schematic illustration of embodiments of a portion of a sampling loop of the sampling system of FIG. 1;

FIG. 4 is a schematic illustration of embodiments of a portion of a sampling loop of the sampling system of FIG. 1;

FIG. 5 is a schematic illustration of embodiments of a portion of a sampling loop of the sampling system of FIG. 1;

FIG. 6 is a schematic illustration of embodiments of a portion of a sampling loop of the sampling system of FIG. 1; and

FIG. 7 is a flowchart of a method for measuring a concentration of material within a volume of a high-temperature liquid in accordance with embodiments of the disclosure.

### DETAILED DESCRIPTION

In various embodiments, the disclosure relates to nuclear material management with continuous online high-temperature liquid sampling and analysis. The high-temperature liquid, such as molten material (e.g., molten salt, without limitation) is drawn into a sampling loop for continuous sampling coupled with one or more spectroscopy techniques configured for online elemental and isotopic analysis. The high-temperature liquid drawn into the sampling loop is aerosolized using a venturi pump nebulizer. The sampling loop includes an optical cell configured to perform multiple spectroscopy techniques continuously and simultaneously to perform online chemical monitoring of the high-temperature liquid. Online chemical monitoring facilitates real-time tracking and management of the chemistry (e.g., chemical composition) of a coolant including the concentration of the nuclear material within the coolant for MSR and pyroprocessing applications. The online chemical monitoring also provides information with regards to other chemistry concerns of the high-temperature liquid (e.g., corrosion products, poisons, and tritium production, without limitation). The real-time tracking and management of the chemistry of the high-temperature liquid may enhance the safeguards for operations using the high-temperature liquids, such as MSR and pyroprocessing applications using molten salts, and, in particular, may enhance the monitoring and tracking of special nuclear material and corrosion products within the molten salt coolant of MSR and pyroprocessing applications.

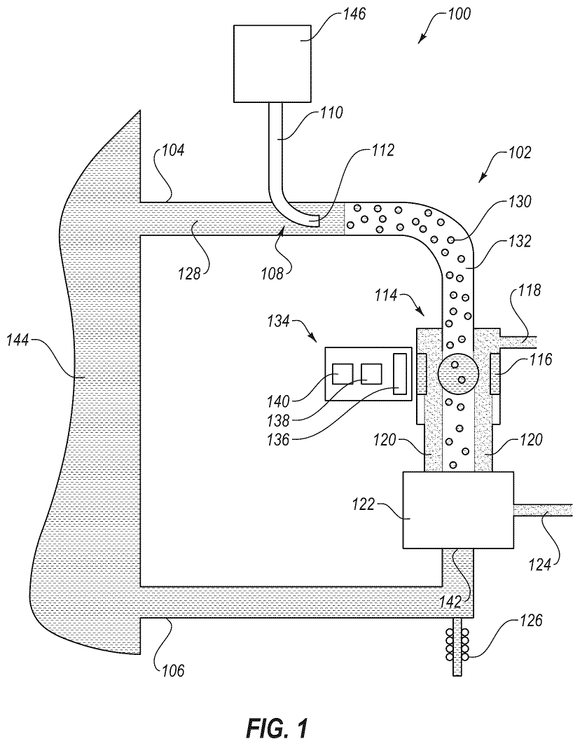

FIG. 1 is a schematic illustration of a sampling system 100 of a volume of a high-temperature liquid 128 in accordance with embodiments of the disclosure. In various embodiments, the sampling system 100 includes a sampling loop 102, a venturi pump nebulizer 108, and an optical cell 114. The sampling system 100 is configured to draw the high-temperature liquid 128 (e.g., molten salt, petroleum, without limitation) into the sampling loop 102 from a high-temperature liquid vessel 144 (e.g., main molten salt reactor of an MSR, molten salt vessel for pyroprocessing, coolant piping of an MSR, or coolant piping for pyroprocessing, without limitation).

The sampling loop 102 includes a liquid inlet 104 configured for the high-temperature liquid 128 to flow into the sampling loop 102 from the high-temperature liquid vessel 144 and a liquid return 106 configured for returning the high-temperature liquid 128 to the high-temperature liquid vessel 144.

The venturi pump nebulizer 108 includes a gas inlet 110 configured to receive a compressed gas (e.g., an inert gas, such as argon or nitrogen for an MSR sampling loop, or air for other high temperature fluids, without limitation) from a gas source 146 and a nozzle 112 positioned in the sampling loop 102 downstream of the liquid inlet 104. The venturi pump nebulizer 108 and, in particular, the nozzle 112, is configured to introduce a gas stream 132 (i.e., a jet of compressed gas) into the sampling loop 102 resulting in a vacuum within the sampling loop 102 drawing the high-temperature liquid 128 into the sampling loop 102 and to aerosolize the high-temperature liquid 128 in the gas stream 132. The nozzle 112 is configured to introduce a highly turbulent flow of the compressed gas to act as a nebulizer to aerosolize the high-temperature liquid 128 into an aerosolized material 130. In various embodiments, the aerosolized material 130 is an aerosolized liquid, which may remain at a high temperature, while passing through the optical cell 114. In various other embodiments, the aerosolized material 130 is cooled or allowed to cool into an aerosolized solid (e.g., the high-temperature liquid 128 freezes into aerosolized solid particles) before passing through the optical cell 114. By using the venturi pump nebulizer 108, the high-temperature liquid 128 can be moved continuously with no moving parts and the flow of high-temperature liquid 128 can be controlled by adjusting the gas pressure provided at the gas inlet 110.

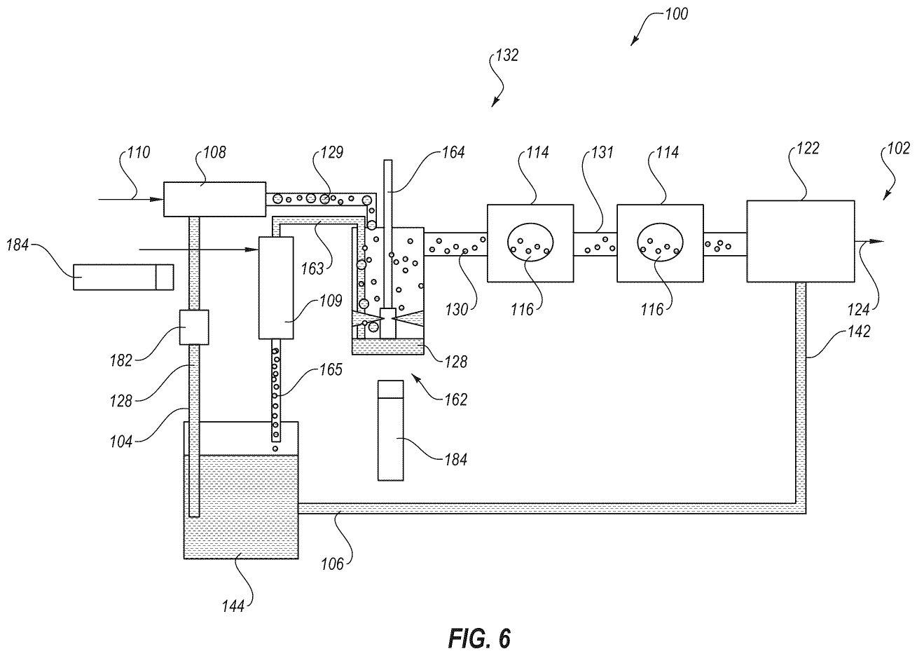

The optical cell 114 is positioned along the sampling loop 102 downstream of the venturi pump nebulizer 108. The optical cell 114 is configured to receive the aerosolized material 130 for on-line chemical monitoring thereof, enabling in-situ and non-destructive analysis of the aerosolized material 130 to identify and quantify at least one type of information chosen from atomic elements, oxidation states, and speciation of corrosion and fission products. In various embodiments, the optical cell 114 includes at least one optical window 116 and is configured for data acquisition to perform the on-line chemical monitoring. In various embodiments, the on-line chemical monitoring includes at least one optical spectroscopy technique chosen from, for example, Laser Ablation molecular isotopic Spectrometry (LAMIS), Laser-Induced Breakdown Spectroscopy (LIBS), Raman Spectroscopy, Infrared (IR) Spectroscopy, Ultraviolet-Visible (UV-VIS) Spectroscopy, and Fluorescence Spectroscopy (e.g., laser-induced fluorescence (LIF)). The online chemical monitoring may be performed on the aerosolized material 130 with the material in a liquid phase or with the material in a solid phase. Some monitoring techniques may be more compatible with the material in the liquid phase, while other techniques may be more compatible with the material in the solid phase. In various embodiments, the sampling loop 102 includes multiple optical cells 114 (refer to FIG. 6) with a first optical cell 114 positioned upstream of a location where the aerosolized material 130 freezes from an aerosolized liquid to an aerosolized solid and a second optical cell 114 positioned downstream of the location where the aerosolized material freezes.

In some of these various embodiments, the optical cell 114 includes multiple optical windows 116 arranged for multiple on-line chemical monitoring techniques, such as multiple optical spectrometry techniques, to be performed on-line simultaneously and continuously. Applying multiple techniques in the same analyte (coupling the techniques into the optical cell 114) may provide more data on the chemistry (e.g., elemental, molecular, isotopes, without limitation) of the high-temperature liquid 128.

In various embodiments, the at least one optical window 116 includes a material with sufficient transmission characteristics when heated above about 600° C. and while operating in high radiation fields (e.g., neutron flux above: 5.0×10¹¹ n/cm²/s and gamma flux above: 28 kGy/h, without limitation). In various embodiments, the at least one optical window 116 includes sapphire.

In various embodiments, the optical cell 114 includes a gas sheath inlet 118 and is configured to generate a gas sheath 120 around the aerosolized material 130 as the aerosolized material 130 passes therethrough.

In various embodiments, the sampling system 100 includes a monitoring system 134 configured to perform online chemical monitoring of the high-temperature liquid 128. In various embodiments, the online chemical monitoring includes the at least one optical spectroscopy technique. The monitoring system 134 includes optics 136 (e.g., optical spectrometer, fiber optics cables, optical components, without limitation), a processor 138, and memory 140. The memory 140, storing computer-executable instructions that, when executed, cause the processor 138 to obtain data from the optics 136 and analyze the data to perform the on-line chemical monitoring, such as spectroscopy measurements of the at least one optical spectroscopy technique. In some of these various embodiments, the monitoring system 134 is configured to combine analysis from multiple spectroscopy techniques together (e.g., two or more of LIBS, LAMIS, and UV-VIS) using one or more models (e.g., chemometric models and multivariate models, without limitation), which may provide a more informed/detailed picture of the composition of the high-temperature liquid 128 and may reduce the uncertainty of the measurements performed thereby. In various embodiments, the on-line chemical monitoring includes isotopic quantification for the high-temperature liquid 128.

In various embodiments, the sampling system 100 includes a filter 122 (e.g., a coalesce filter for a liquid aerosolized material 130 or a conventional filter for a solid/frozen aerosolized material 130, without limitation) positioned downstream of the optical cell 114 on the sampling loop 102 and configured to separate the aerosolized material 130 from the gas stream 132. The filter 122 includes a gas outlet 124 and a liquid outlet 142. In various embodiments, the gas outlet 124 is configured to return the gas to the gas source 146. The liquid return 106 is configured to return the high-temperature liquid 128 exiting the filter 122 to the high-temperature liquid vessel 144.

In various embodiments, the sampling system 100 includes a valve 126 positioned on the sampling loop 102 and configured for extraction (e.g., removal) of discrete samples of the high-temperature liquid 128. In various embodiments, the valve 126 is positioned downstream of the filter 122. In some of these various embodiments, the valve 126 is a freeze valve and includes a freeze plug. Analysis techniques for the samples of high-temperature liquid 128 may include destructive analysis (DA) techniques such as inductively coupled plasma mass spectroscopy (ICP-MS) or Thermal Ionization Mass Spectrometry (TIMS).

In embodiments where the aerosolized material 130 is allowed to freeze, either before or after the optical cell 114, a collection of individual or agglomerated particles may be obtained. In some of these embodiments, a sample may be obtained by swapping the filters. The sample may be collected and one or more DA techniques may be performed on the sample. The results of the DA from these samples represent an average of the composition of the high-temperature liquid 128 since the previously conducted filter exchange.

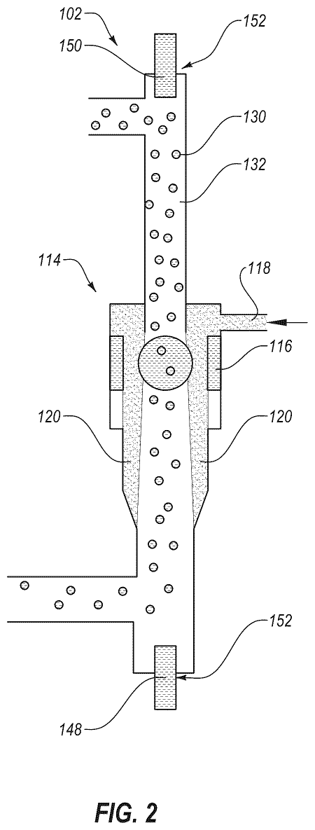

FIG. 2 is a schematic illustration of embodiments of a portion of a sampling loop 102 of the sampling system 100 of FIG. 1. Referring to FIG. 2, the sampling loop 102 includes optical access ports 148 and 150. In the embodiments illustrated in FIG. 2, the sampling loop 102 includes multiple optical access configurations including a transverse configuration (e.g., a viewing configuration perpendicular to the flow of the aerosolized material 130) via the optical cell 114 and the at least one optical window 116 and an in-line configuration (e.g., a viewing configuration parallel to the flow of the aerosolized material 130) via the optical access ports 148 and 150. The optical access ports 148 and 150 are positioned at opposite ends of a substantially linear (e.g., straight) portion of the sampling loop 102. The optical access ports 148 and 150 are arranged for taking measurements (e.g., spectroscopy measurements, such as UV-VIS measurements, without limitation) along/parallel to an axis of the straight portion of the sampling loop 102/flow of the aerosolized material 130. In various embodiments, the optical access ports 148 are positioned in elbows of the sampling loop 102.

In various embodiments, a length of the straight portion of the sampling loop 102 is adjustable, which allows for adjusting an optical path between the optical access ports 148 and 150. In some of these embodiments, the optical path between the optical access ports 148 and 150 is adjustable from about 5 centimeters to about 30 centimeters. In other embodiments, the optical path is adjustable beyond 30 centimeters. The adjustable lengths of the optical path may be optimized based on the measurements being made utilizing the optical access ports 148 and 150.

In various embodiments, the optical access port 148 is an inlet and the optical access port 150 is an outlet. The optical access port 148 is configured for directing light into the sampling loop parallel to the axis of the straight portion of the sampling loop 102/flow of the aerosolized material 130. The optical access port 150 is configured to capture the light/signals for the measurements (e.g., spectroscopy measurements, without limitation). In other embodiments, the optical access port 150 is an inlet and the optical access port 148 is an outlet. In various embodiments, an optical path available via the optical access ports 148, 150 is a fixed length. A beam diameter for taking measurements (e.g., spectroscopy measurements, such as UV-VIS measurements, without limitation) may be adjusted to obtain varying measurements. In some of these embodiments, the optical access port 150 is configured to receive an iris that is configured to control the amount of light passing through the optical cell 114 to reduce the signal.

In various embodiments, a cover gas inlet 152 is positioned at each of the optical access ports 148, 150. The cover gas inlets 152 are configured to shield optical components at the optical access ports 148, 150 from interaction/contact with the aerosolized material 130.

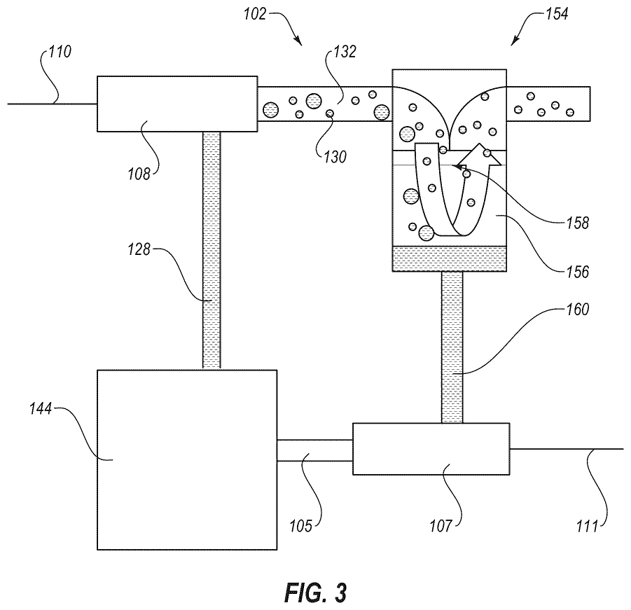

FIG. 3 is a schematic illustration of embodiments of a portion of a sampling loop 102 of the sampling system 100 of FIG. 1. Referring to FIG. 3, the sampling loop 102 includes the venturi pump nebulizer 108 and a vessel and baffle system 154. The vessel and baffle system 154 includes one or more collection vessels 156 and one or more baffles 158 positioned within the one or more collection vessels 156. The vessel and baffle system 154 is positioned downstream of the venturi pump nebulizer 108 and is configured to capture any of the high-temperature liquid 128 and droplets thereof that may be too large to be carried in the gas stream 132. In various embodiments, the vessel and baffle system 154 further includes a drain 160 configured to return the high-temperature liquid 128 collected in the one or more collection vessels 156 to the high-temperature liquid vessel 144.

In various embodiments, another venturi pump nebulizer 107 is positioned at an end of the drain 160. The venturi pump nebulizer 107 includes a gas inlet 111 that is configured to cause the high-temperature fluid captured in the vessel and baffle system 154 to return to the high-temperature liquid vessel 144 via a liquid return line 105.

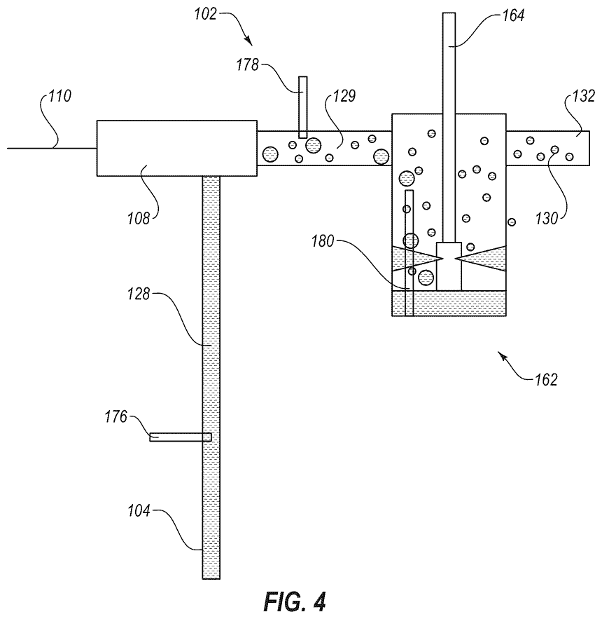

FIG. 4 is a schematic illustration of embodiments of a portion of a sampling loop 102 of the sampling system 100 of FIG. 1. Referring to FIG. 4, in the embodiments illustrated in FIG. 4, the sampling loop 102 includes the venturi pump nebulizer 108 and a nebulizer 162. The nebulizer 162 is positioned downstream of the venturi pump nebulizer 108. The nebulizer 162 is configured to receive a sample and gas mixture 129 including a gas and the high-temperature liquid 128, that may be partially aerosolized in the gas, from the venturi pump nebulizer 108. The nebulizer 162 is configured to ensure the high-temperature liquid 128 is aerosolized prior to being fed to the optical cell 114. In various embodiments, the nebulizer 162 is a recirculating nebulizer (e.g., a Collison nebulizer, without limitation). The nebulizer 162 includes a gas inlet 164 for supplying a compressed gas (e.g., an inert gas, such as argon or nitrogen for an MSR sampling loop, or air for other high temperature fluids, without limitation) to the nebulizer 162.

The sampling loop 102 may include various probes for monitoring the sampling system 100. In the embodiments illustrated in FIG. 4, the sampling loop 102 includes probes 176, 178, 180. The probe 176 is configured to monitor the high-temperature liquid 128 and is positioned, for example, in the liquid inlet 104. The probe 178 is configured to monitor the gas stream 132 and the aerosolized material 130 and is positioned, for example, downstream of the venturi pump nebulizer 108, and the probe 180 is configured to monitor fluid levels in the nebulizer 162 and is positioned within and at least partially immersed in a chamber of the nebulizer 162. The probes 176, 178, 180 may include temperature sensors, flow meters, fluid level sensors, and the like.

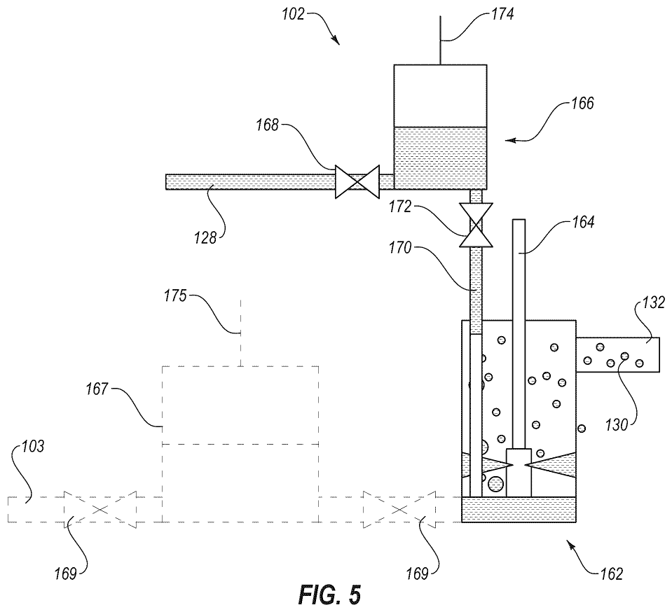

FIG. 5 is a schematic illustration of embodiments of a portion of a sampling loop 102 of the sampling system 100 of FIG. 1. Referring to FIG. 5, in various embodiments, the sampling loop 102 includes a secondary vessel 166 and a nebulizer 162. In these various embodiments, the sampling loop 102 includes an inlet flow control valve 168 positioned upstream of the secondary vessel 166 and configured to control flow of the high-temperature liquid 128 into the secondary vessel 166, a discharge line 170 configured to control discharge of the high-temperature liquid 128 out of the secondary vessel 166 and into the nebulizer 162, and a discharge flow control valve 172 to control flow of the high-temperature liquid 128 into the nebulizer 162 from the secondary vessel 166. In various embodiments, the secondary vessel 166 includes a pressure control 174 configured to supply a pressure to the secondary vessel 166 sufficient for causing the high-temperature liquid 128 to flow to the nebulizer 162. The nebulizer 162 includes a gas inlet 164 for supplying a compressed gas (e.g., an inert gas, such as argon or nitrogen for an MSR sampling loop, or air for other high temperature fluids, without limitation) to the nebulizer 162. The nebulizer 162 is configured to aerosolize the high-temperature liquid 128.

In various embodiments, the arrangement of the secondary vessel 166 and the nebulizer 162 is configured to be used in conjunction with any of the embodiments disclosed above. In other various embodiments, the arrangement of the secondary vessel 166 and the nebulizer 162 is configured to replace arrangements with the venturi pump nebulizer 108.

In various embodiments, the discharge line 170 extends into the nebulizer 162 and establishes a fluid level for the high-temperature liquid 128 collected therein. In other various embodiments, a secondary tank 167 is connected to the nebulizer 162 and is configured to drain the high-temperature liquid 128 from the nebulizer 162. The secondary tank 167 may also include a pressure control 175 configured to supply a pressure to the secondary tank 167 sufficient for causing the high-temperature liquid 128 to flow to the high-temperature liquid vessel 144 via a liquid return line 103. Flow control valves 169 may be upstream and/or downstream of the secondary tank 167 to control flow from the nebulizer 162, into the secondary tank 167, and out of the secondary tank 167.

FIG. 6 is a schematic illustration of embodiments of a sampling loop 102 of the sampling system 100 of FIG. 1. Referring to FIG. 6, in various embodiments, the sampling loop 102 includes a flow cell 182 positioned on the liquid inlet 104 of the sampling loop 102 (i.e., the liquid uptake side of the venturi pump nebulizer 108). One or more online chemical monitoring techniques may be performed on the high-temperature liquid 128 via the flow cell 182. For example, with a fixed path length through the liquid, a spectroscopy technique, such as UV-VIS, may be performed by capturing data at the flow cell 182 on the liquid inlet 104.

In various embodiments, the sampling system 100 includes one or more radiation detectors 184 positioned along the sampling loop 102 to capture data from the high-temperature liquid 128. In the embodiment illustrated in FIG. 6, a radiation detector 184 is positioned along the liquid inlet 104 of the sampling loop 102 (i.e., the liquid uptake side of the venturi pump nebulizer 108) to capture data from the high-temperature liquid 128 flowing therethrough, and a radiation detector 184 is positioned at the nebulizer 162 to capture data from the high-temperature liquid 128 collecting within the nebulizer 162. Other locations for a radiation detector 184, such as at the liquid outlet 142 of the filter 122 or at the filter 122 (on the high-temperature liquid accumulated therein), are also contemplated.

The one or more radiation detectors 184 may be utilized to perform non-destructive assay (NDA) techniques on the high-temperature liquid 128. NDA techniques may be utilized where the high-temperature liquid 128 includes one or more radioactive components (e.g., uranium, plutonium, or fission products, without limitation), one or more rare earth elements, etc. The NDA techniques may include gamma and neutron spectroscopy. The gamma spectroscopy may be performed using a high-purity germanium (HPGe) radiation detector or a cadmium zinc telluride (CZT) radiation detector. Neutron counting techniques or a combination of neutron and gamma techniques may be used.

In various embodiments, the sampling loop 102 includes multiple optical cells 114. While the optical cells 114 are shown in series in the embodiment illustrated in FIG. 6, in other embodiments, the optical cells 114 are arranged in parallel. In various embodiments, the aerosolized material 130 is cooled or allowed to cool into an aerosolized solid (e.g., the high-temperature liquid 128 freezes into aerosolized solid particles) in a fluid line 131 upstream of an optical cell 114 (e.g., between two optical cells 114, without limitation), which allows for online chemical monitoring techniques to be performed on the aerosolized material 130 with the material in the liquid phase and the aerosolized material 130 with the material in the solid phase.

In various embodiments, the sampling system 100 includes a venturi pump nebulizer 109 positioned between the nebulizer 162 and the high-temperature liquid vessel 144. An uptake tube 163 connects the venturi pump nebulizer 109 to the nebulizer 162. The uptake tube 163 extends into the nebulizer 109 with an end thereof positioned at a height to maintain a set level of the high-temperature liquid 128 therein. The venturi pump nebulizer 109 returns some of the high-temperature liquid 128 to the high-temperature liquid vessel 144 via a return line 165. With this configuration, the high-temperature liquid 128 from the high-temperature liquid vessel 144 is constantly being circulated through the nebulizer 162 where NDA may be performed via the radiation detector 184 and optical spectroscopy may be performed via a flow cell 182 positioned thereby. While some latency may occur (e.g., a few seconds depending on a distance to the nebulizer 162 from the high-temperature liquid vessel 144), the constant exchange of the high-temperature liquid 128 results in the data collected from the high-temperature liquid 128 within the nebulizer 162 accurately reflecting the properties of the high-temperature liquid 128 within the high-temperature liquid vessel 144.

In various embodiments, the liquid return 106 includes one or more pressure tanks and a system of valves (e.g., two-way valves and check valves, without limitation) to return the high-temperature liquid 128 to the high-temperature liquid vessel 144, which may minimize gas mixing into the high-temperature liquid vessel 144. Using pressure tanks connected with a two-way valve may allow for precise control of the return of the high-temperature liquid 128 to the high-temperature liquid vessel 144.

Any of the arrangements of FIGS. 1, 3, 4, 5, and/or 6 may be used in parallel to control various aspects of the sampling process. For example, the venturi pump nebulizer 108 of FIG. 3 or 4, with either the vessel and baffle system 154 or the nebulizer 162 downstream thereof, is arranged in parallel with the venturi pump nebulizer 108 of FIG. 1. The venturi pump nebulizer 108 of FIG. 1 is arranged to direct samples to the valve 126 at a rate faster than that of the venturi pump nebulizer 108 of FIG. 3 or 4 with either the vessel and baffle system 154 or the nebulizer 162 downstream thereof for quick extraction of discrete samples of the high-temperature liquid 128. The venturi pump nebulizer 108 of FIG. 3 or 4 is arranged to create the sample stream of the gas stream 132 and the aerosolized material 130 directed to one or more optical access configurations. The flow cell 182 of FIG. 6 may, for example, be used on the liquid uptake side of the venturi pump nebulizer 108 to any of the arrangements of FIGS. 1, 3, 4, and 5. The one or more radiation detectors 184 may be utilized at locations of the arrangements of FIGS. 1, 3, 4, and 5 where the high-temperature liquid 128 (not mixed with gas) is flowing or collecting.

Other configurations are also contemplated, such as one or more venturi pump nebulizers 108 configured to direct a sample stream, via one or more valves, directly to a valve 126 for quick extraction of discrete samples of the high-temperature liquid 128 or to either the vessel and baffle system 154 or the nebulizer 162 for further processing of the sample stream prior to directing the sample stream to one or more optical access configurations. In some embodiments, the valve 126 for the vessel and baffle system 154 or the nebulizer 162 is positioned within a sampling loop 102 that is separate from the one or more optical access configurations and that includes a separate venturi pump nebulizer 162.

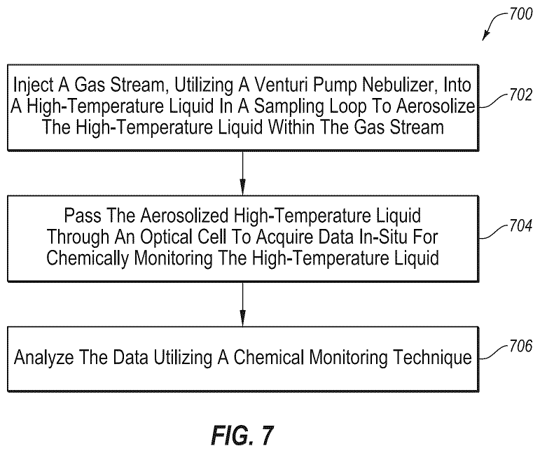

FIG. 7 is a flowchart of a method 700 for measuring a concentration of material within a volume of a high-temperature liquid in accordance with embodiments of the disclosure. The method 700 includes injecting a gas stream, utilizing a venturi pump nebulizer, into a high-temperature liquid in a sampling loop to aerosolize the high-temperature liquid within the gas stream at act 702. The method also includes passing the aerosolized high-temperature liquid through an optical cell to acquire data in-situ for chemically monitoring the high-temperature liquid at act 704. In various embodiments, act 704 includes utilizing optics, such as fiber optics and an optical spectrometer to acquire the data. The method 700 further includes analyzing the data utilizing a chemical monitoring technique at act 706. In various embodiments, the chemical monitoring technique is chosen from one or more of LAMIS, LIBS, Raman Spectroscopy, IR Spectroscopy, UV-VIS Spectroscopy, and Fluorescence Spectroscopy. In various embodiments, act 706 includes performing multiple on-line chemical monitoring techniques simultaneously and continuously. In some of these various embodiments, act 706 includes coupling multiple spectroscopy approaches together using one or more models.

In various embodiments, the method includes filtering the aerosolized high-temperature liquid from the gas stream and returning the high-temperature liquid to a high-temperature liquid vessel.

In various embodiments, the method includes removing a sample from the sampling loop via a freeze valve to perform an offline chemical monitoring technique on the sample.

In various embodiments, the method includes performing one or more online chemical monitoring techniques on the high-temperature liquid via a flow cell positioned on a liquid uptake side of the venturi pump nebulizer.

In various embodiments, the method includes performing one or more NDA techniques utilizing one or more radiation detectors positioned along the sampling loop.

In various embodiments, the aerosolized high-temperature liquid freezes into an aerosolized material in a solid phase, and the method includes collecting individual or agglomerated particles of the aerosolized material from a filter.

As noted above, the sampling system utilizes a compressed gas operated venturi pump nebulizer in a sampling loop that both acts as a pump to draw a high-temperature liquid into the sampling loop and aerosolizes the high-temperature liquid within the compressed gas. The aerosolized high-temperature liquid is passed through an optical cell, which is used to perform chemical monitoring of the high-temperature liquid. Coupling the venturi pump nebulizer with the optical cell may provide the capability of continuous operation at high temperatures for online sampling of high-temperature liquids that greatly enhances the information available for process monitoring and nuclear safeguards of the high-temperature liquid, such as molten salt utilized in MSR and pyroprocessing applications. Multiple chemical monitoring processes may be combined in on-line processes utilizing the optical cell, which may further enhance safeguards and processes utilizing high-temperature liquids, such as the nuclear safeguards, reactor operation, and chemistry control in MSRs.

The various illustrative logical blocks, modules, and circuits described in connection with the embodiments of the monitoring system disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

As used herein, the terms “adapted,” “configured,” and “configuration” refers to a size, a shape, a material composition, a material distribution, orientation, and arrangement of at least one feature (e.g., one or more of at least one structure, at least one material, at least one region, at least one device) facilitating use of the at least one feature in a pre-determined way.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

Although the disclosure has been illustrated and described herein with reference to various embodiments and specific examples thereof, it will be readily apparent to those of ordinary skill in the art that other embodiments and examples may perform similar functions and/or achieve like results. All such embodiments and examples are within the spirit and scope of the disclosure, are contemplated thereby, and are encompassed by the following claims and legal equivalents thereof.

What is claimed is:

1. A sampling system for a high-temperature liquid, comprising:
a sampling loop including a liquid inlet configured for the high-temperature liquid to flow into the sampling loop from a high-temperature liquid vessel and a liquid return configured for returning the high-temperature liquid to the high-temperature liquid vessel;
a venturi pump nebulizer including a nozzle positioned in the sampling loop downstream of the liquid inlet, the nozzle configured to introduce a gas stream into the sampling loop to produce a vacuum within the sampling loop that draws the high-temperature liquid into the sampling loop and aerosolizes the high-temperature liquid in the gas stream; and
an optical cell configured to receive the aerosolized high-temperature liquid for chemical monitoring thereof, the optical cell including at least one optical window configured for data acquisition to perform on-line chemical monitoring.

2. The sampling system of claim 1, further comprising a filter downstream of the optical cell in the sampling loop, the filter configured to separate the high-temperature liquid from the gas stream.

3. The sampling system of claim 2, a valve downstream of the filter on a liquid return line of the sampling loop, the valve configured for removing a sample of the high-temperature liquid from the sampling loop.

4. The sampling system of claim 1, wherein the optical cell includes a gas sheath inlet, the optical cell configured to generate a gas sheath around the aerosolized high-temperature liquid passing through the optical cell.

5. The sampling system of claim 1, further comprising a recirculating nebulizer positioned downstream of the venturi pump nebulizer and upstream of the optical cell on the sampling loop.

6. The sampling system of claim 1, further comprising a vessel and baffle system positioned downstream of the venturi pump nebulizer and upstream of the optical cell on the sampling loop.

7. The sampling system of claim 1, further comprising a flow cell positioned on a liquid uptake side of the venturi pump nebulizer, the flow cell configured for performing one or more online chemical monitoring techniques on the high-temperature liquid.

8. The sampling system of claim 1, further comprising one or more radiation detectors positioned along the sampling loop, the one or more radiation detectors configured for performing one or more non-destructive assay techniques.

9. The sampling system of claim 8, further comprising:
a recirculating nebulizer positioned downstream of the venturi pump nebulizer and upstream of the optical cell on the sampling loop;
a radiation detector of the one or more radiation detectors positioned to obtain data from the high-temperature liquid collected in the recirculating nebulizer;
a second venturi pump nebulizer positioned between the recirculating nebulizer and the high-temperature liquid vessel; and
an uptake tube connecting the second venturi pump nebulizer to the recirculating nebulizer, the uptake tube extending into the recirculating nebulizer with an end thereof positioned at a height to maintain a set level of the high-temperature liquid within the recirculating nebulizer.

10. The sampling system of claim 1, further comprising a monitoring system, the monitoring system comprising:
optics configured to acquire data in-situ via the optical cell through which passes the aerosolized high-temperature liquid for chemically monitoring the high-temperature liquid;
a processor; and
memory storing computer-executable instructions that, when executed, cause the processor to obtain the data from the optics and analyze the data utilizing a chemical monitoring technique.

11. The sampling system of claim 10, wherein analyzing the data utilizing the chemical monitoring technique includes combining analysis from multiple spectroscopy techniques together using multiple models including chemometric models and multivariate models.

12. A method for measuring a concentration of material within a high-temperature liquid, the method comprising:
injecting a gas stream, utilizing a venturi pump nebulizer, into a high-temperature liquid in a sampling loop to aerosolize the high-temperature liquid within the gas stream;
passing the aerosolized high-temperature liquid through an optical cell to acquire data in-situ for chemically monitoring the high-temperature liquid; and
analyzing the data utilizing a chemical monitoring technique.

13. The method of claim 12, wherein the analyzing the data utilizing the chemical monitoring technique includes combining analysis from multiple spectroscopy techniques together using multiple models including chemometric models and multivariate models.

14. The method of claim 12, further comprising filtering the aerosolized high-temperature liquid from the gas stream and returning the high-temperature liquid to a high-temperature liquid vessel.

15. The method of claim 12, wherein the aerosolized high-temperature liquid freezes into an aerosolized material in a solid phase, the method further comprising collecting individual or agglomerated particles of the aerosolized material from a filter.

16. The method of claim 12, further comprising removing a sample of the high-temperature liquid from the sampling loop via a freeze valve to perform an offline chemical monitoring technique on the sample.

17. The method of claim 12, further comprising performing one or more online chemical monitoring techniques on the high-temperature liquid via a flow cell positioned on a liquid uptake side of the venturi pump nebulizer.

18. The method of claim 12, further comprising performing one or more non-destructive assay techniques utilizing one or more radiation detectors positioned along the sampling loop.

19. The method of claim 12, wherein the chemical monitoring technique is chosen from one or more of LAMIS, LIBS, Raman Spectroscopy, IR Spectroscopy, UV-VIS Spectroscopy, and Fluorescence Spectroscopy.

20. The method of claim 12, wherein injecting a gas stream, utilizing a venturi pump nebulizer, into a high-temperature liquid in a sampling loop to aerosolize the high-temperature liquid within the gas stream further utilizes a recirculating nebulizer positioned downstream of the venturi pump nebulizer.
